(19) United States
(12) Patent Application Publication
(10) Pub. No.: US 2014/0037860 A1
(43) Pub. Date: Feb. 6, 2014

(54) ARTICLE, ESPECIALLY CABLE SHEATHING, COMPRISING THERMOPLASTIC POLYURETHANE AND CROSSLINKED POLYETHYLENE IN ADHESIVE-BONDED FORM

(71) Applicant: BASF SE, Ludwigshafen (DE)

(72) Inventors: Klaus HILMER, Brockum (DE); Aleksander Glinka, Lemfoerde (DE); Oliver Muehren, Osnabrueck (DE)

(73) Assignee: BASF SE, Ludwigshafen (DE)

(21) Appl. No.: 14/051,049

(22) Filed: Oct. 10, 2013

Related U.S. Application Data
(62) Division of application No. 12/517,465, filed on Jun. 3, 2009, now abandoned.

(30) Foreign Application Priority Data
Dec. 21, 2006 (EP) 06126739.9

(51) Int. Cl. B05D 3/04

(52) U.S. Cl. CPC B05D 3/0446
USPC 427/536

(57) ABSTRACT

Item comprising thermoplastic polyurethane adhesively bonded to crosslinked polyethylene without any chemical adhesion promoter.

### CROSS-REFERENCE TO RELATED APPLICATIONS

The present application is a divisional of U.S. application Ser. No. 12/517,465, filed June 3, 2009, the entire content of which is incorporated herein by reference. U.S. application Ser. No. 12/517,465 is a national stage of PCT/EP2007/063751, filed Dec. 12, 2007 and claims benefits of priority to European Application 06126739.9, filed Dec. 21, 2006.

The invention relates to items, in particular cable sheathing, comprising thermoplastic polyurethane preferably adhesively bonded to crosslinked polyethylene without any chemical adhesion promoter. “Without any chemical adhesion promoter” here means that between the thermoplastic polyurethane and the crosslinked polyethylene there is no further component (adhesion promoter) present, i.e. no component which differs from the polyethylene and from the thermoplastic polyurethane, in particular no adhesive. The crosslinked polyethylene and the thermoplastic polyurethane are separate in the item of the invention, but adhesively bonded to one another. The items of the invention are not therefore based on a mixture comprising crosslinked polyethylene together with thermoplastic polyurethane. The invention further relates to processes for the production of an item, in particular cable sheathing, comprising thermoplastic polyurethane and crosslinked polyethylene, where the surface of the crosslinked polyethylene is plasma-treated and then the thermoplastic polyurethane, preferably in a molten state, is brought into contact with the plasma-treated surface. The invention also relates to items thus obtainable, in particular cable sheathing.

The sheathing of cables with polyethylene is well known. However, a disadvantage of these polyethylene-sheathed cables is that their abrasion resistance is often unsatisfactory, and it is therefore desirable to sheath the polyethylene with a plastic which has better mechanical properties.

It was therefore an object of the present invention to develop, for cable sheathing, an adherent combination of materials in which an advantageous material is sheathed by a material which has very good mechanical properties. This composite element should feature efficient and effective manufacture together with maximum adhesion even when no adhesion promoters are used.

These objects were achieved via the items described in the introduction, in which thermoplastic polyurethane and crosslinked polyethylene are present in a direct adhesive composite.

The item of the invention is preferably cable sheathing, as described in the introduction. The actual cable here, for example copper cable, is sheathed by the crosslinked polyethylene, and the crosslinked polyethylene is sheathed by the thermoplastic polyurethane. It is particularly preferable that this is therefore cable sheathing in which a sleeve based on crosslinked polyethylene has been sheathed with thermoplastic polyurethane.

The thickness of the sleeve composed of crosslinked polyethylene here is preferably from 1 to 4 mm. The thickness of the sheath composed of thermoplastic polyurethane is preferably from 0.2 to 3 mm.

A feature of the items of the invention is that a thermoplastically processable plastic having excellent suitability as cable sheathing, i.e. polyethylene, which is crosslinked after application to the cable, is directly adhesively bonded to a thermoplastic, in this case thermoplastic polyurethane. The thermoplastic polyurethane here provides a surface finish which in particular markedly improves the mechanical properties of the cable.

Another particular feature of the items of the invention is the excellent adhesion between the crosslinked polyethylene and the thermoplastic polyurethane. Particular preference is therefore also given to items in which the peel resistance to DIN EN 1464 is at least 2 N/mm.

The thermoplastic polyurethane of the invention is preferably a thermoplastic polyurethane whose Shore hardness is greater than 90 A, particularly preferably a thermoplastic polyurethane whose Shore hardness is from 95 A to 74 D, and whose tensile strength to DIN 53504 is greater than 30 MPa, and whose tear-propagation resistance to DIN 53515 is greater than 40 N/mm, and whose abrasion to DIN 53516 is smaller than 250 mm³.

A further object was to develop an effective process of maximum efficiency which can produce the items described in the introduction, and in particular can achieve the adhesive bond by simple means.

This object was achieved via processes for the production of an item, in particular cable sheathing, comprising thermoplastic polyurethane and crosslinked polyethylene, preferably items comprising thermoplastic polyurethane adhesively bonded to crosslinked polyethylene without any chemical adhesion promoter, where the surface of an item, preferably cable sheathing comprising crosslinked polyethylene, is plasma-treated, and then the thermoplastic polyurethane, preferably in a molten state, is brought into contact with the plasma-treated surface, this process preferably being carried out continuously.

The cable sheathing of the invention can be produced by well known processes where, for the production of the adhesive bond, after the production of the polyethylene sheathing, the surface of the polyethylene is preferably treated with plasma, and then the crosslinked polyethylene is sheathed by thermoplastic polyurethane. It is preferable that the polyethylene is applied in non-crosslinked form, i.e. in a thermoplastic state, to the cable, and then crosslinked, and then plasma-treated, and that the thermoplastic polyurethane is then applied. The production process is particularly preferably continuous. Sheathing processes are described by way of example in: “Kabel und isolierte Leitungen”, pages 201 ft Auslegen von Ummantelungswerkzeugen fur Kabel und Leitungen [Design of sheathing tools for cables and lines], VDI-Verlag, 1984, ISBN 3-18-404105-0.

In a preferred process for production of the items of the invention comprising thermoplastic polyurethane adhesively bonded to crosslinked polyethylene, the surface of an item based on crosslinked polyethylene is plasma-treated, and then the thermoplastic polyurethane in a molten state is brought into contact with the plasma-treated surface. In a preferred process here, the surface of crosslinked polyethylene sleeving the cable is plasma-treated, and then the thermoplastic polyurethane in a molten state is extruded onto the plasma-treated surface of the crosslinked polyethylene.

Crosslinkable polyethylene and its processing and crosslinking are well known. Materials of this type are commercially available.

The plasma treatment of thermoplastics is described in DE-B 103 08 727, DE-A 103 08 989, and also by Simon Amesoder et al., Kunststoffe 9/2003, pages 124 to 129.

By virtue of this process of the invention it is possible for the first time to achieve an adhesive bond between crosslinked polyethylene and thermoplastic polyurethane in cable sheathing without any chemical adhesion promoter. An additional advantage is that this bond is at the same time achieved by means of an effective and efficient process.

Plasma treatment is well known and is described by way of example in the references cited in the introduction. Examples of apparatuses for plasma treatment are obtainable from Plasmatreat GmbH, Bisamweg 10, 33803 Steinhagen.

It is preferable that a plasma is generated by means of high-voltage discharge in a plasma source, and this plasma is brought into contact, by means of a plasma nozzle, with the surface of the polyethylene, and the plasma source is moved within a distance of from 2 mm to 25 mm with a velocity of from 0.1 m/min to 40 m/min, preferably from 0.1 m/min to 20 m/min, relative to the surface of the component which is plasma-treated. The plasma is preferably transported via gas flow along the discharge path onto the surface of the polyethylene. Particular activated particles which may be mentioned as present within the plasma and serving for preparation of the surface of the plastic for adhesion, are ions, electrons, free radicals, and photons. Gases that can be used comprise oxygen, nitrogen, carbon dioxide, and mixtures composed of the abovementioned gases, preferably air, in particular compressed air. The gas flow rate can amount to 2 m³/h per nozzle. The operating frequency can be from 10 to 30 kHz. The excitation voltage or the electrode voltage can be from 5 to 10 kV. Static or rotating plasma nozzles can be used. The surface temperature of the component can be from 5° C. to 250° C., preferably from 5° C. to 200° C.

Preference is therefore given to a process in which a plasma is generated by means of high-voltage discharge in a plasma source, and this plasma is brought into contact, by means of a plasma nozzle, with the surface of the crosslinked polyethylene, and the plasma source is moved within a distance of from 2 mm to 25 mm with a velocity of from 0.1 m/min to 40 m/min relative to the surface of the component which is plasma-treated, and the surface to be treated here is preferably continuously conducted past the plasma source.

Well known processes can be used for the application of the thermoplastic polyurethane to the plasma-treated surface of the crosslinked polyethylene, an example being extrusion of commercially available thermoplastic polyurethanes. The processing temperature of thermoplastic polyurethane here is preferably from 140 to 250° C., particularly preferably from 160 to 230° C. Thermoplastic polyurethanes, also termed TPUs in this specification, are preferably processed under very mild conditions. The temperatures can be adjusted as a function of hardness. TPUs and processes for their production are well known. TPUs are generally produced via reaction of (a) isocyanates with (b) compounds which are reactive toward isocyanates and whose molar mass (Mw) is usually from 500 to 10 000, preferably from 500 to 5000, particularly preferably from 800 to 3000, and (c) chain extenders whose molar mass is from 50 to 499, if appropriate in the presence of (d) catalysts and/or (e) conventional additives.

TPUs according to WO 03/014179 are preferred because of their particularly good adhesion. The descriptions below as far as the examples relate to these particularly preferred TPUs. These TPUs have particularly good adhesion, since the processing temperatures are higher than with other “traditional” TPUs with comparable hardness values, and the best bond strengths are achievable under these conditions. These particularly preferred TPUs are preferably obtainable via reaction of (a) isocyanates with (b1) polyesterdiols whose melting point is greater than 150° C., (b2) polyetherdiols and/or polyesterdiols respectively with melting point below 150° C. and with molar mass of from 501 to 8000 g/mol, and also, if appropriate, (c) diols whose molar mass is from 62 g/mol to 500 g/mol. Particular preference is given here to thermoplastic polyurethanes in which the molar ratio of the diols (c) with molar mass from 62 g/mol to 500 g/mol to component (b2) is smaller than 0.2, particularly preferably from 0.1 to 0.01.

The term “melting point” in this specification means the maximum of the melting peak of a heating curve measured using a commercially available DSC device (e.g. DSC 7 from Perkin-Elmer).

The molar masses stated in this specification are number-average molar masses in [g/mol].

In a preferred method of producing these particularly preferred thermoplastic polyurethanes, a preferably high-molar-mass, preferably semicrystalline, thermoplastic polyester can be reacted with a diol (c), and then the reaction product from (i) comprising (b1) polyesterdiol whose melting point is greater than 150° C., and also, if appropriate, (c) diol together with (b2) polyetherdiols and/or polyesterdiols each of whose melting points is smaller than 150° C., and each of whose molar masses is from 501 to 8000 g/mol, and also, if appropriate, with further (c) diols whose molar mass is from 62 to 500 g/mol, can be reacted with (a) isocyanate, if appropriate in the presence of (d) catalysts, and/or (e) auxiliaries.

The molar ratio of the diols (c) whose molar mass is from 62 to 500 g/mol to component (b2) in the reaction (ii) is preferably smaller than 0.2, preferably from 0.1 to 0.01.

While the first step (i) provides the hard phases for the final product by virtue of the polyester used in step (i), use of component (b2) in step (ii) constructs the soft phases. The preferred technical teaching consists in melting, preferably in a reactive extruder, polyesters having a well-developed hard-phase structure which crystallizes well, and first degrading these with a low-molar-mass diol to give shorter polyesters having free hydroxy end groups. The original high crystallization tendency of the polyester is retained here and can then be utilized for a fast reaction to obtain TPU with the advantageous properties, these being high tensile strength values, low abrasion values, and high heat resistance values due to the high and narrow melting range, and low compression-set values. The preferred process therefore preferably uses low-molar-mass diols (c) to degrade high-molar-mass, semicrystalline, thermoplastic polyesters under suitable conditions in a short reaction time to give polyesterdiols (b1) which crystallize rapidly and which in their turn are then incorporated with other polyesterdiols and/or polyetherdiols and diisocyanates into high-molar-mass polymer chains.

The molar mass of the thermoplastic polyester used here, i.e. prior to the reaction (i) with the diol (c) is preferably from 15 000 g/mol to 40 000 g/mol, its melting point at this stage preferably being greater than 160° C., particularly preferably from 170° C. to 260° C.

The starting material used, i.e. the polyester which in step (i), preferably in the molten state, particularly preferably at a temperature of from 230° C. to 280° C., is reacted with the diol(s) (c), preferably for a period of from 0.1 min to 4 min, particularly preferably from 0.3 min to 1 min, can comprise well-known, preferably high-molar-mass, preferably semicrystalline, thermoplastic polyesters, for example in pelletized form.

Suitable polyesters are based by way of example on aliphatic, cycloaliphatic, araliphatic, and/or aromatic dicarboxylic acids, e.g. lactic acid and/or terephthalic acid, and also on aliphatic, cycloaliphatic, araliphatic, and/or aromatic dialcohols, e.g. 1,2-ethanediol, 1,4-butanediol, and/or 1,6-hexanediol.

Polyesters particularly preferably used are: poly-L-lactic acid and/or polyalkylene terephthalate, e.g. polyethylene terephthalate, polypropylene terephthalate, polybutylene terephthalate, and in particular polybutylene terephthalate.

The preparation of these esters from the starting materials mentioned is well known to the person skilled in the art and has been widely described. Suitable polyesters are moreover commercially available.

The thermoplastic polyesters are preferably melted at a temperature of from 180° C. to 270° C. The reaction (i) with the diol (c) is preferably carried out at a temperature of from 230° C. to 280° C., preferably from 240° C. to 280° C.

The diol (c) used in step (i) for the reaction with the thermoplastic polyester and, if appropriate, in step (ii) can comprise well-known diols whose molar mass is from 62 to 500 g/mol, e.g. the diols mentioned below, e.g. ethylene glycol, 1,3-propanediol, 1,4-butanediol, 1,5-pentanediol, 1,6-hexanediol, heptanediol, octanediol, and preferably 1,4-butanediol and/or 1,2-ethanediol.

The ratio by weight of the thermoplastic polyester to the diol (c) in step (i) is usually from 100:1.0 to 100:10, preferably from 100:1.5 to 100:8.0.

The reaction of the thermoplastic polyester with the diol (c) in reaction step (i) is preferably carried out in the presence of conventional catalysts, e.g. those described below. Catalysts on the basis of metals are preferably used for this reaction. The reaction in step (i) is preferably carried out in the presence of from 0.1 to 2% by weight of catalyst, based on the weight of the diol (c). The reaction is advantageous in the presence of these catalysts, the aim being to permit conduct of the reaction in the reactor in the short residence time available, for example in the reactive extruder.

Examples of catalysts that can be used for this reaction step (i) are: tetrabutyl orthotitanate and/or stannous dioctoate, preferably stannous dioctoate.

The molar mass of the polyesterdiol (b1) as reaction product from (i) is preferably from 1000 to 5000 g/mol. The melting point of the polyesterdiol as reaction product from (i) is preferably from 150° C. to 260° C., in particular from 165° C. to 245° C., i.e. the reaction product of the thermoplastic polyester with the diol (c) in step (i) comprises compounds with the melting point mentioned, these being used in the subsequent step (ii).

By virtue of the reaction of the thermoplastic polyester with the diol (c) in step (i), the polymer chain of the polyester is cleaved via transesterification by virtue of the diol (c). The reaction product of the TPU therefore has free hydroxy end groups and is preferably further processed in the further step (ii) to give the actual product, the TPU.

The reaction of the reaction product from step (i) in step (ii) preferably takes place via addition of a) isocyanate (a), and also (b2) polyetherdiols and/or polyesterdiols, each of whose melting points is smaller than 150° C. and each of whose molar masses is from 501 to 8000 g/mol, and also, if appropriate, further (c) diols whose molar mass is from 62 to 500 g/mol, (d) catalysts, and/or (e) auxiliaries to the reaction product from (i). The reaction of the reaction product with the isocyanate takes place by way of the hydroxy end groups produced in step (i). The reaction in step (ii) preferably takes place at a temperature of from 190° C. to 250° C., preferably for a period of from 0.5 to 5 min, particularly preferably from 0.5 to 2 min, preferably in a reactive extruder, which is particularly preferably the same as the reactive extruder in which step (i) has also been carried out. By way of example, the reaction of step (i) can take place in the first barrel sections of a conventional reactive extruder, and the corresponding reaction of step (ii) can be carried out at a subsequent point, i.e. in subsequent barrel sections, after addition of components (a) and (b2). By way of example, the first 30-50% of the length of the reactive extruder can be used for step (i), and the remaining 50-70% for step (ii).

The reaction in step (ii) preferably takes place with an excess of the isocyanate groups with respect to the groups reactive toward isocyanates. The ratio of the isocyanate groups to the hydroxy groups in the reaction (ii) is preferably from 1:1 to 1.2:1, particularly preferably from 1.02:1 to 1.2:1.

It is preferable to carry out the reactions (i) and (ii) in a well-known reactive extruder. These reactive extruders are described by way of example in the company publications of Werner & Pfleiderer or in DE-A 2 302 564.

The preferred process is preferably carried out as follows: at least one thermoplastic polyester, e.g. polybutylene terephthalate, is fed into the first barrel section of a reactive extruder and melted at temperatures which are preferably from 180° C. to 270° C., preferably from 240° C. to 270° C., and a diol (c), e.g. butanediol, and preferably a transesterification catalyst, is added into a subsequent barrel section, and at temperatures of from 240° C. to 280° C. the polyester is degraded by the diol (c) to give polyester oligomers having hydroxy end groups and molar masses of from 1000 to 5000 g/mol, and in a subsequent barrel section isocyanate (a) and (b2) compounds which are reactive toward isocyanate and whose molar mass is from 501 to 8000 g/mol, and also, if appropriate, (c) diols whose molar mass is from 62 to 500, (d) catalysts, and/or (e) auxiliaries are metered in, and then, at temperatures of from 190° C. to 250° C., the preferred thermoplastic polyurethanes are constructed.

It is preferable that in step (ii), except for the diols (c) which are obtained in the reaction product (i) and whose molar mass is from 62 to 500, no diols (c) whose molar mass is from 62 to 500 are introduced.

In the region in which the thermoplastic polyester is melted, the reactive extruder preferably has neutral and/or backward-conveying kneading blocks and backward-conveying elements, and in the region in which the thermoplastic polyester is reacted with the diol it preferably has screw mixing elements, toothed disks, and/or toothed mixing elements in combination with backward-conveying elements.

After the reactive extruder, the clear melt is usually introduced by means of a gear pump to underwater pelletization and pelletized.

The particularly preferred thermoplastic polyurethanes exhibit optically clear, single-phase melts, which solidify rapidly and, as a consequence of the semicrystalline polyester hard phase, form moldings which are slightly opaque to non-transparent white. The rapid solidification is a decisive advantage over known formulations and production processes for thermoplastic polyurethanes. The rapid solidification is so pronounced that even products whose hardness values are from 50 to 60 Shore A can be processed by injection molding with cycle times smaller than 35 s. In extrusion, too, for example in blown-film production, absolutely none of the problems typical of TPU arise, examples being sticking or blocking of the films or bubbles.

The proportion of the thermoplastic polyester in the final product, i.e. in the thermoplastic polyurethane, is preferably from 5 to 75% by weight. The preferred thermoplastic polyurethanes are particularly preferably products of the reaction of a mixture comprising from 10 to 70% by weight of the reaction product from (i), from 10 to 80% by weight of (b2), and from 10 to 20% by weight of (a), the weight data given being based on the total weight of the mixture comprising (a), (b2), (d), (e), and the reaction product from (i).

1. A process for the production of an item comprising thermoplastic polyurethane adhesively bonded to crosslinked polyethylene, which comprises plasma-treating the surface of an item based on crosslinked polyethylene and then bringing the thermoplastic polyurethane in a molten state into contact with the plasma-treated surface.

2. A process for the production of a sheathed cable comprising thermoplastic polyurethane adhesively bonded to crosslinked polyethylene, which comprises plasma-treating the surface of crosslinked polyethylene which sleeves the cable, and then extruding the thermoplastic polyurethane in a molten state onto the plasma-treated surface of the crosslinked polyethylene.

3. The process according to claim 1, wherein a plasma is generated by means of high-voltage discharge in a plasma source, and this plasma is brought into contact, by means of a plasma nozzle, with the surface of the crosslinked polyethylene, and the plasma source is moved within a distance of from 2 mm to 25 mm with a velocity of from 0.1 m/min to 40 m/min relative to the surface of the component which is plasma-treated. The surface to be treated here is continuously conducted past the plasma source.

4. The process according to claim 1, wherein the Shore A hardness of the thermoplastic polyurethane is greater than 90 A.

5. The process according to claim 1, wherein the Shore hardness of the thermoplastic polyurethane is from 95 A to 74 D, its tensile strength to DIN 53504 is greater than 30 MPa, its tear-propagation resistance to DIN 53515 is greater than 40 N/mm, and its abrasion to DIN 53516 is smaller than 250 mm³.

6. The process according to claim 2, wherein a plasma is generated by means of high-voltage discharge in a plasma source, and this plasma is brought into contact, by means of a plasma nozzle, with the surface of the crosslinked polyethylene, and the plasma source is moved within a distance of from 2 mm to 25 mm with a velocity of from 0.1 m/min to 40 m/min relative to the surface of the component which is plasma-treated. The surface to be treated here is continuously conducted past the plasma source.

7. The process according to claim 2, wherein the Shore A hardness of the thermoplastic polyurethane is greater than 90 A.

8. The process according to claim 2, wherein the Shore hardness of the thermoplastic polyurethane is from 95 A to 74 D, its tensile strength to DIN 53504 is greater than 30 MPa, its tear-propagation resistance to DIN 53515 is greater than 40 N/mm, and its abrasion to DIN 53516 is smaller than 250 mm³.
